(19) United States
(12) Patent Application Publication
(10) Pub. No.: US 2001/0034691 A1
(43) Pub. Date: Oct. 25, 2001

(54) System and method for facilitating time and equity limited financial transactions across a computer network

(75) Inventors: Kevin Guarino, Garden City, NY (US); Robert Mitchell, Williston Park, NY (US); Robert Henrichs, New Hyde Park, NY (US); Joseph Lombardo, Hicksville, NY (US)

Correspondence Address: FLEIT, KAIN, GIBBONS,, GUTMAN & BONGINI, P.L., ONE BOCA COMMERCE CENTER, 551 NORTHWEST 77TH STREET, SUITE 111, BOCA RATON, FL, 33487, US

(73) Assignee: Tradegame International, Inc., Lake Success, NY

(21) Appl. No.: 09/778,686

(22) Filed: Feb. 7, 2001

Related U.S. Application Data
(60) Provisional application No. 60/180,812, filed on Feb. 7, 2000.

(51) Int. Cl. G06F 17/60

(52) U.S. Cl. 705/37

(57) ABSTRACT

A financial transaction system is accessible by users across a computer network, such as via a web site on the Internet. Each of the users is associated with at least one certain contract that limits their transactions by time, by equity, by number of trades, and by other parameters. Each user can request financial transactions, e.g., place trades, across the computer network while a financial transaction administrative server verifies and limits the transactions made by the user according to the particular at least one contract associated with the user.

### TECHNICAL FIELD

This invention relates in general to online and wide area network based financial transaction systems, and more particularly to a networked system for administering financial transactions for users on the network.

### DESCRIPTION OF THE PRIOR ART

Online trading of stocks and other such securities is becoming very popular with investors. The convenience and speed of access to trading markets makes this type of electronic trading very desirable to sophisticated investors.

Margin trading allows sophisticated traders to buy and sell stocks at stock brokerage houses while only paying a portion of the value of the stock up front. Essentially the stock brokerage service extends a loan to such a trader while the value of the investment stays above a certain minimal threshold amount. Investments of amounts greater than the available financial assets of an investor are possible. This typically limits margin trading to an investment mechanism for sophisticated investors. A main concern for investors of margin trading, for example, is the volatility of direct stock trading with no downside limits. A margin call from a brokerage service will call the margin trading loan from the investor while typically putting the investor at high risk of losing significant additional personal assets, well beyond the amount currently invested.

Unfortunately, there has been no financial trading system providing the advantages of online trading while limiting investor's downside risk. Thus, there is a need for a system to facilitate financial transactions via a computer network to allow investors, especially those less sophisticated investors, to take advantage of online trading while limiting their downside risk.

### BRIEF DESCRIPTION OF THE DRAWINGS

FIGS. 1 to 3 are flow diagrams illustrating operational sequences in a financial transaction system, in accordance with a preferred embodiment of the present invention.

FIG. 1 depicts how the system creates an account and the parameters utilized in the Customer Table.

FIG. 2 describes how the system executes and organizes BUY transactions using established parameters for Customer Table (account/contract updates), Transaction Table (for Buy and Stop Loss parameter updates) and Portfolio Table (inventory assessment).

FIG. 3 shows how the system executes and organizes Sell transactions using established parameters for Customer Table (account/contract updates), Transaction Table (for Sell parameter updates) and Portfolio Table (inventory assessment).

FIG. 4 is a block diagram illustrating an exemplary computer network and financial transaction system according to a preferred embodiment of the present invention.

FIG. 5 is a block diagram illustrating a computer network and a more detailed view of a financial transaction administrative system according to a preferred embodiment of the present invention.

FIGS. 6 to 11 are flow diagrams, labeled Diagram 1 thru Diagram 6, respectively, illustrating an exemplary operational sequence for requesting financial transactions, e.g., placing a trade, according to a preferred embodiment of the present invention.

FIGS. 12 to 32 are display screen views, labeled screen 1 to screen 21, illustrating exemplary display screens for users of a financial transaction administrative system, such as via web pages, according to a preferred embodiment of the present invention.

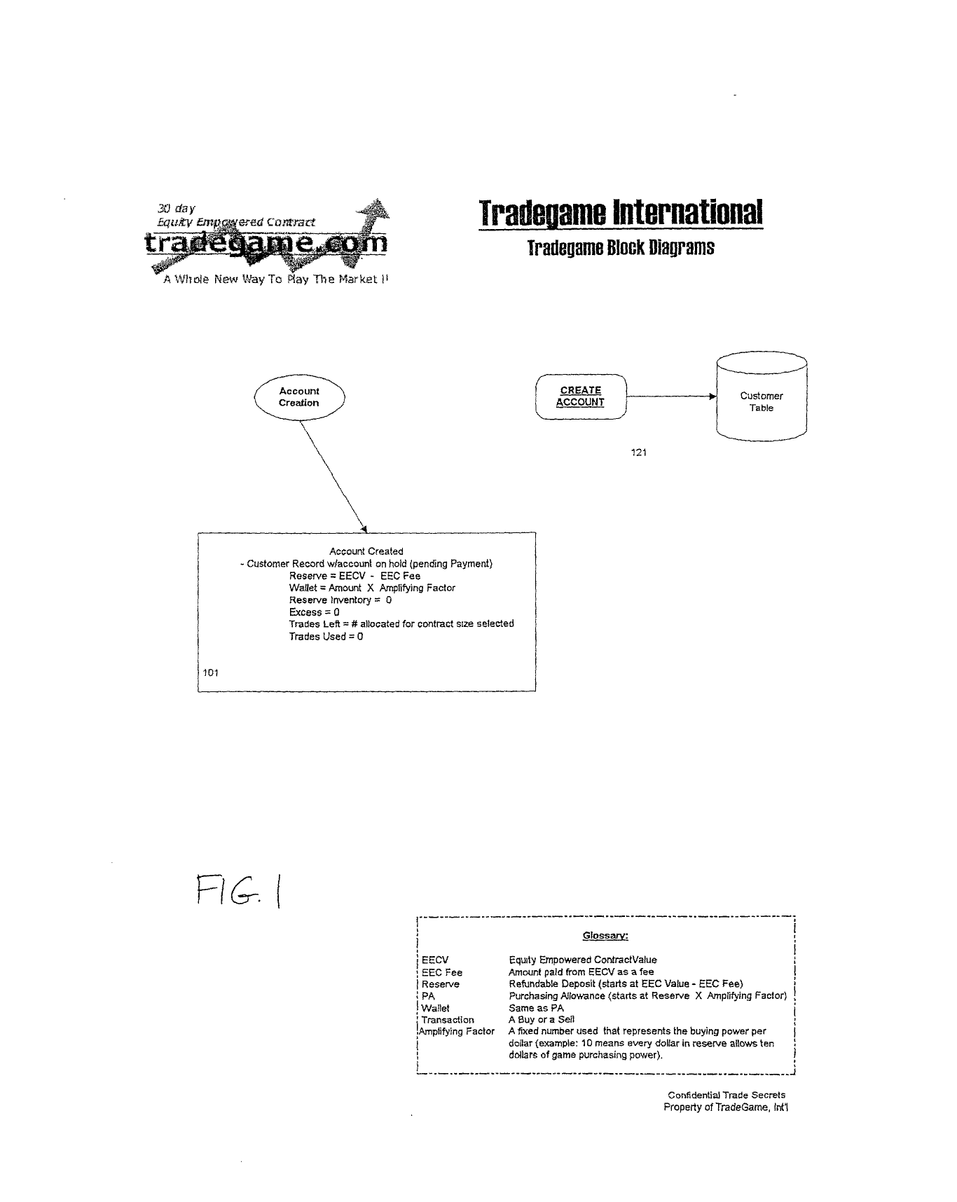

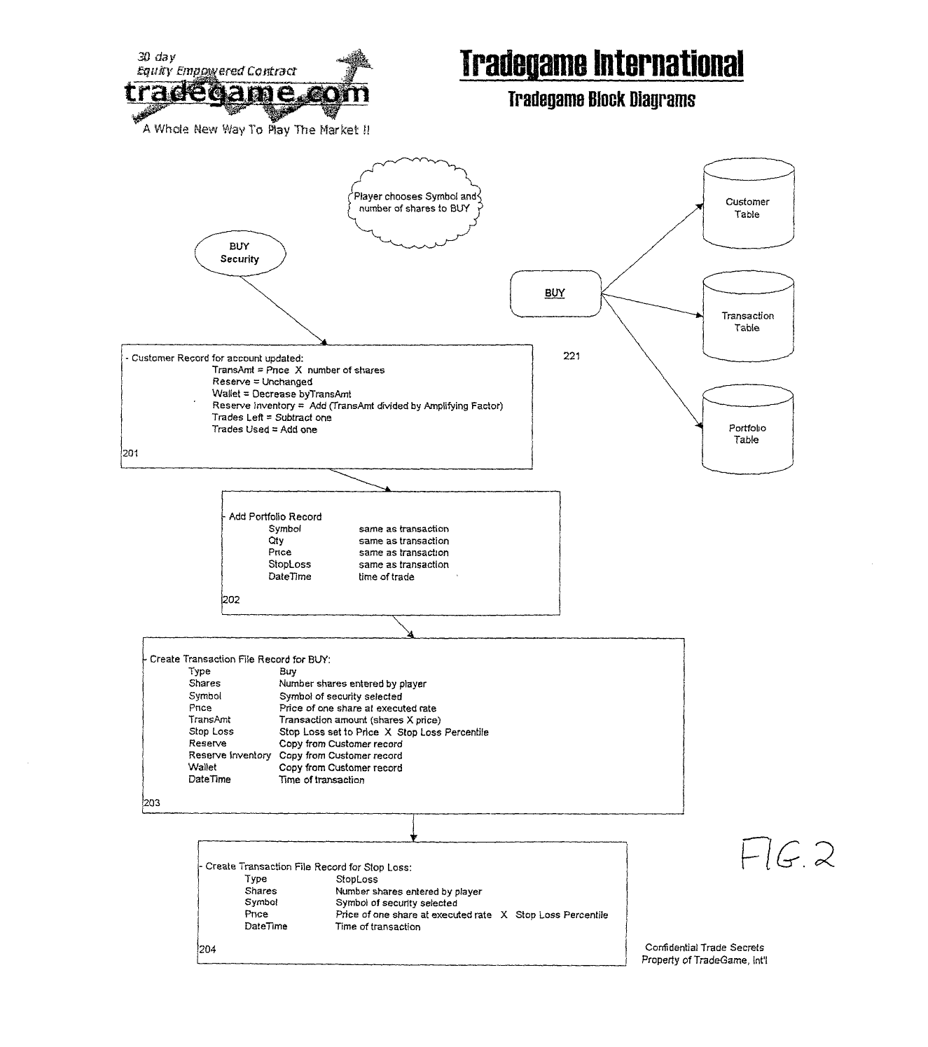

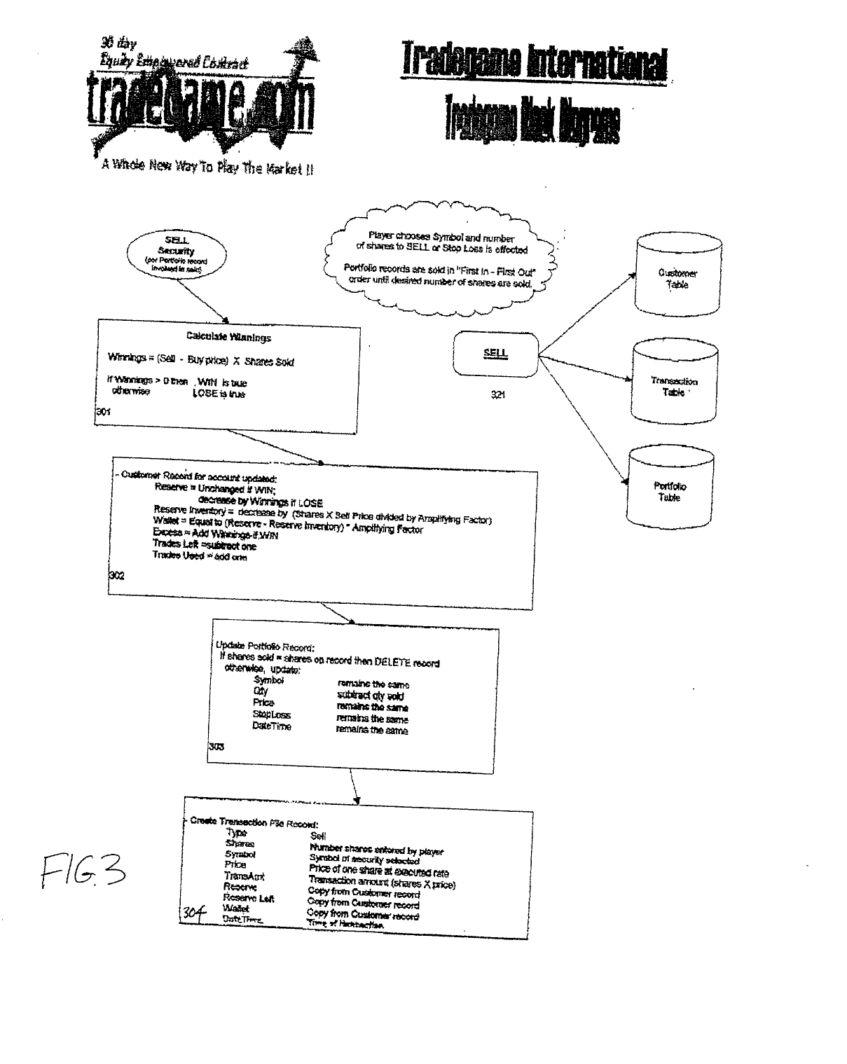

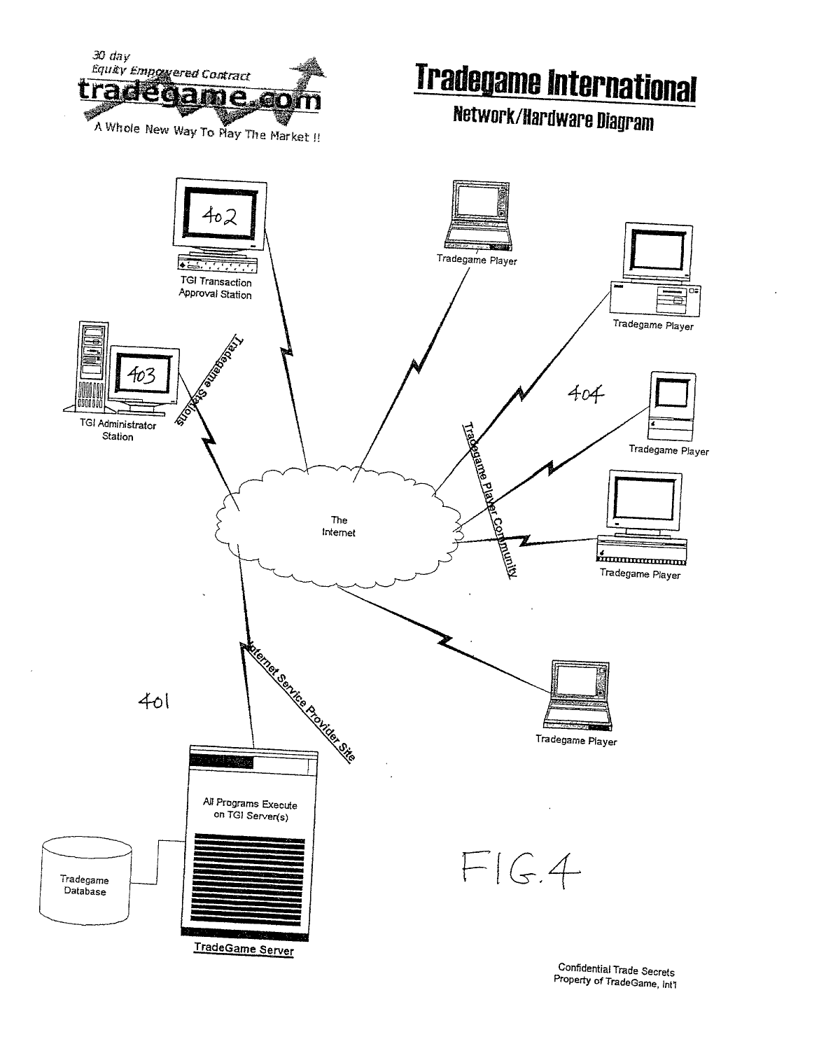

### DESCRIPTION OF THE PREFERRED EMBODIMENTS

This invention utilizes a new method for a financial transaction administration system to facilitate remotely located users making financial transactions, e.g., trade requests, across a computer network while limiting the financial transactions by time, by equity, by number of trades, and by other parameters, according to at least one contract associated with each user.

TradeGame Overview:

Tradegame is a game played by members known as the “players”. Each player can use a computer device (see diagram element 404), such as a PC, a handheld computer, or other portable communication device, to communicate with a central financial transaction administrative system, comprising a server 401 and administrative computer stations 402, 403, that communicate messages with the user's computer device 404 across a wide area network such as the Internet, or other similar type of message communication network.

A player sends a message to the central financial transaction administrative system to sign up and, when approved by the system the system creates an account for the user. Account creation sets a group of parameters: the Wallet, the Reserve Deposit, the Reserve Inventory, Excess and number of trades. This account corresponds to at least one record in a database for the central financial transaction administrative system. After account creation, the player forwards payment to the central system, and when accepted the payment amount is applied to the player's account. The account is then activated by TGI personnel, such as from the administrative computer stations 402, 403. This initiates an Equity Empowered Contract (EEC) and marks the beginning of the contract's lifetime.

Tradegame players can trade stocks within the limits of the EEC selected. Profits and Losses are determined by the actual the performance of the selected stocks on their corresponding exchange(s) during the limited timeframe they are actually held by each individual EEC owner in the Tradegame environment.

The Account Creation Process (see diagram element 101)

Account creation begins when the prospective player selects “sign up” on the web page, the player passes through three pages, filling in answers for the account type selected (e.g. Individual, Joint, etc.) regarding identity, address, demographic, net worth and other identifying information. An account record is placed on file and marked as “Pending Payment”. The player then sends payment via selected method(s) and TGI personnel mark the account as activated.

Account Activation

Once payment has cleared, the account status is changed from “Pending Payment” to “Active” and the EEC start date is placed on the player's record. An eMail message is sent at the same time to the player's eMail address containing account number, username and password.

BUY Transaction (see diagram elements 201-204)

The Tradegame player selects a stock and share amount for a Buy transaction. The trade amount is then calculated using the number of share times the current ask price for that security. If the trade amount is less than or equal to the amount in the Wallet, the trade is allowed. The trade is recorded by creating a Transaction record and Portfolio record. Also, customer record balances and counters are updated.

For each BUY transaction, TGI places a stop loss order at a certain percentage below the purchase price as a protection measure.

SELL Transaction (see diagram elements 301-304)

The Tradegame player selects a stock in his Portfolio and a share amount for a Sell transaction. The trade amount is then calculated using the number of shares times the current bid price for that security. If the trade amount is less than or equal to the amount of shares in the Portfolio the trade is allowed. The trade is recorded by creating a Transaction record and a Portfolio record. Customer record balances and counters are updated. All Sell transactions follow the First In-First Out accounting principles currently utilized in the United States to determine actual profits and losses. This clarifies issues of multiple Buys and partial Sells.

For each SELL transaction TGI removes the corresponding stop loss order. Regarding partial Sell transactions of a given security, the original stop loss is cancelled and a new stop loss is entered with the original execution price and lowered share amount.

In addition, a SELL transaction can be automatically initiated when a Stop Loss becomes activated. This occurs when the corresponding stock drops in price and the Bid price becomes less than or equal to the Stop Loss price.

Any calculated losses that may occur are indicated by a corresponding reduction in the Reserve amount. Any calculated gains that may occur are indicated by a corresponding increase in the Excess amount.

Lastly, in certain instances all remaining positions in the TG environment are automatically closed out and Sold by TGI on the Termination date at the bid price of all remaining stocks in Portfolio at 12:30 pm of such date.

Contract Termination

An EEC contract is automatically terminated:

1. at the end of EEC lifetime as defined

2. when all allowable trades are consumed as per selected EEC.

3. when Reserve Amount falls below a defined monetary level (unless the optional “Excess Transfer Option” or “Replenish Option” is activated by Player).

Contract Completion

An EEC is completed as follows:

1. EEC contract becomes terminated.

2. Check is forwarded to Player within seven business days of Termination Date. Amount of check is determined by remaining Reserve and Excess amount(s).

Additionally, as further examples and according to the preferred embodiments of the present invention, the following list of attachments are incorporated by reference into this patent application.

Attachments:

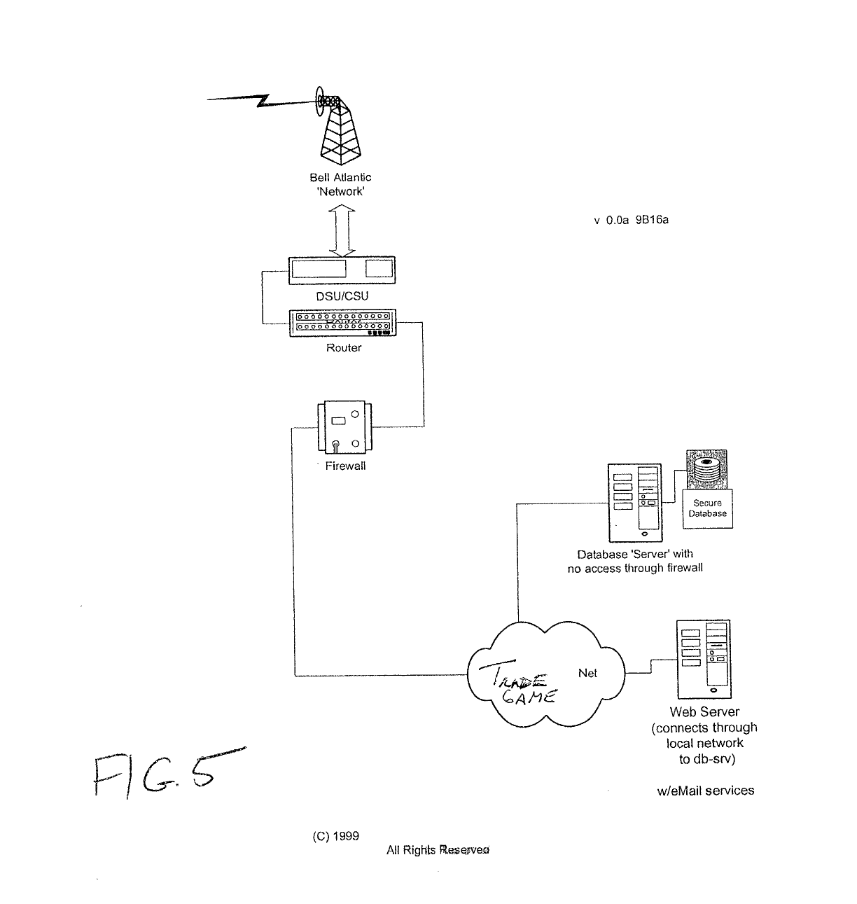

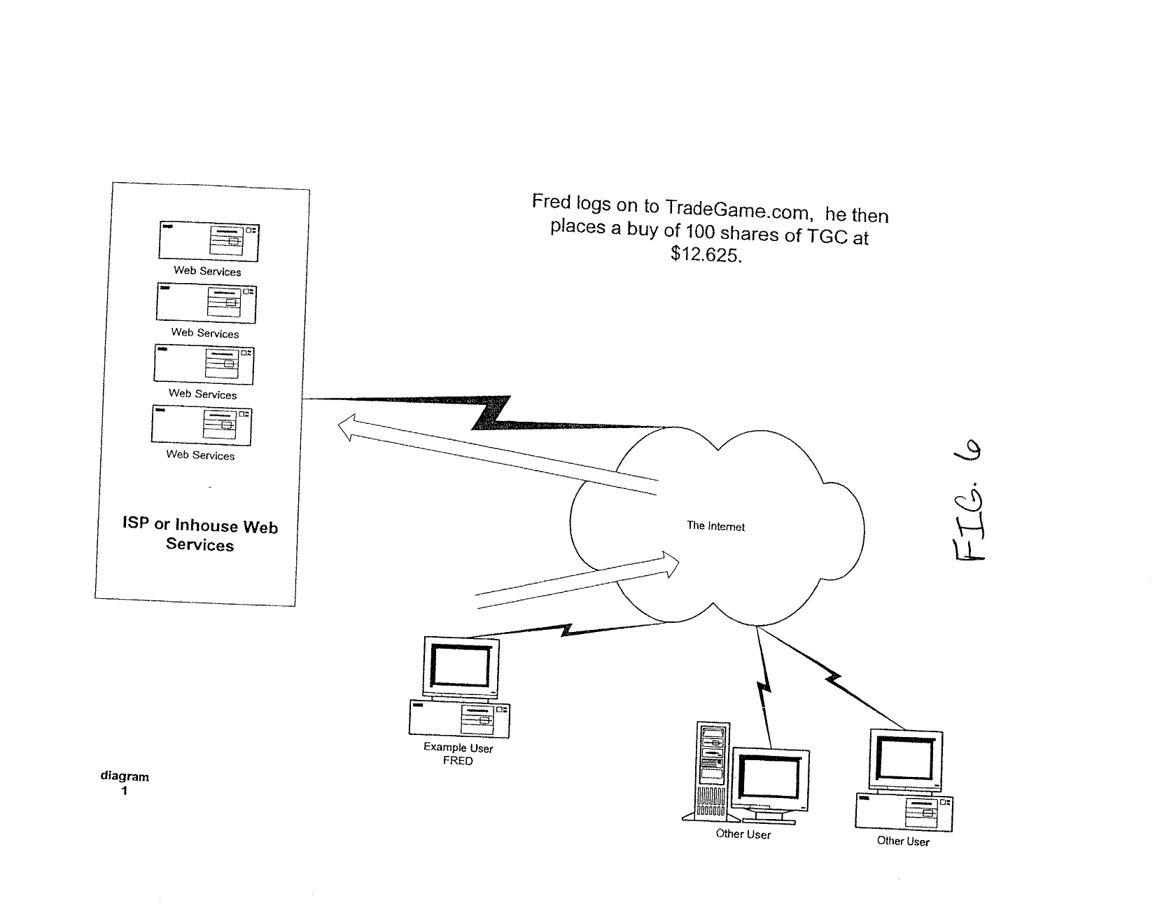

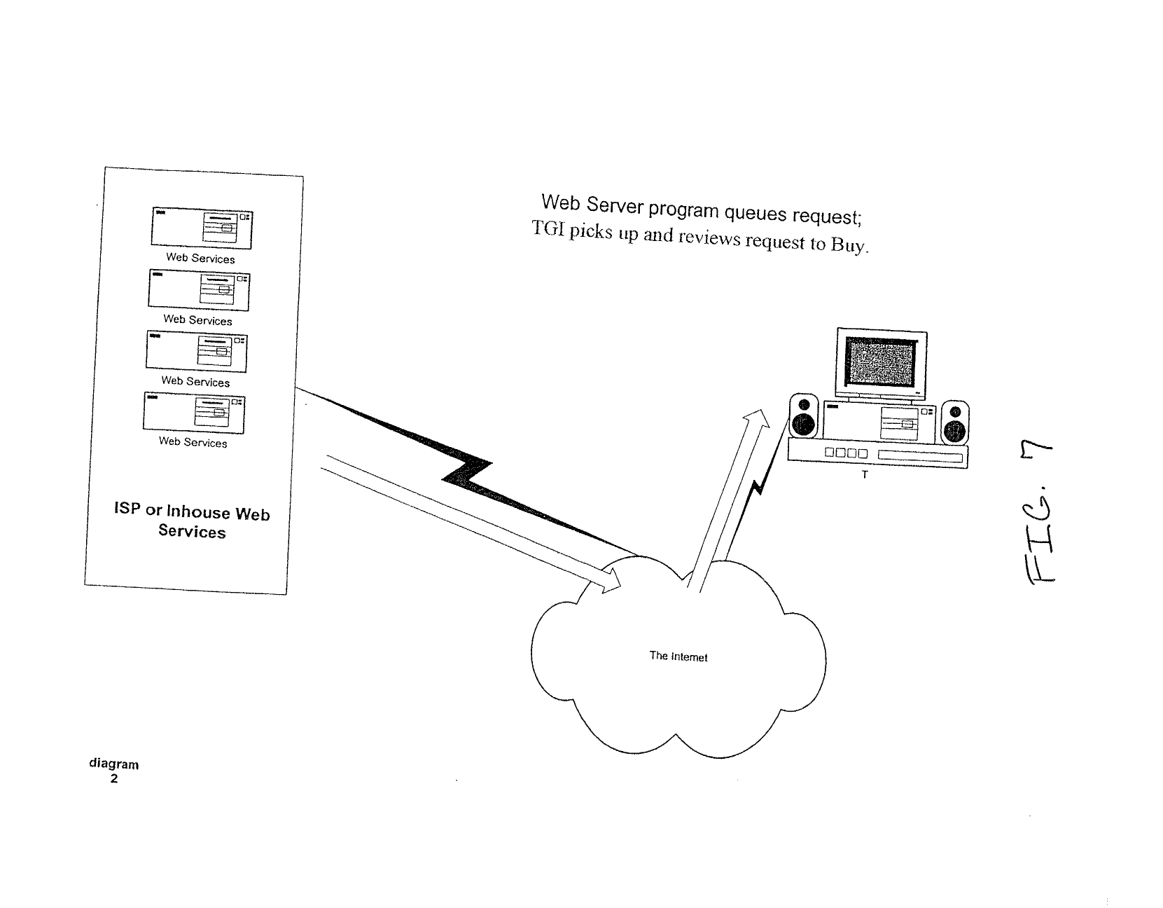

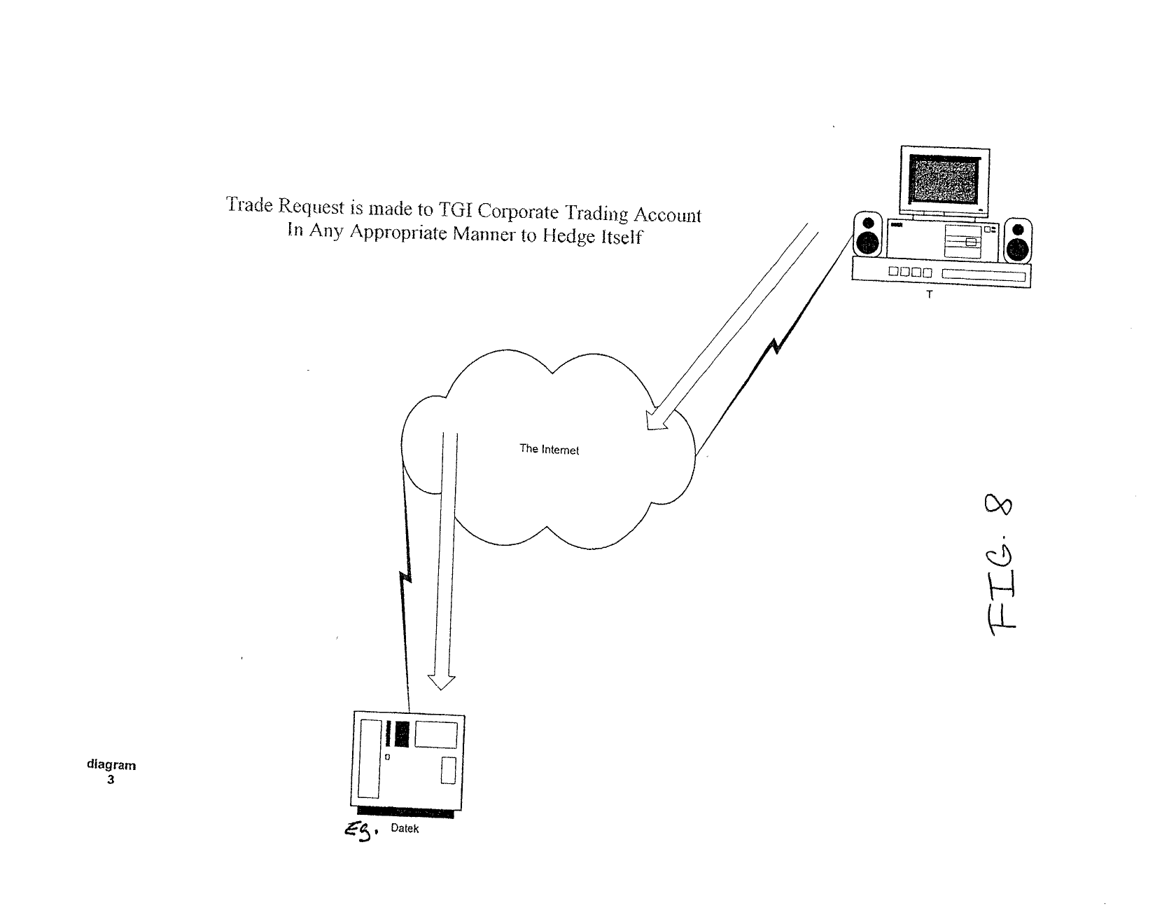

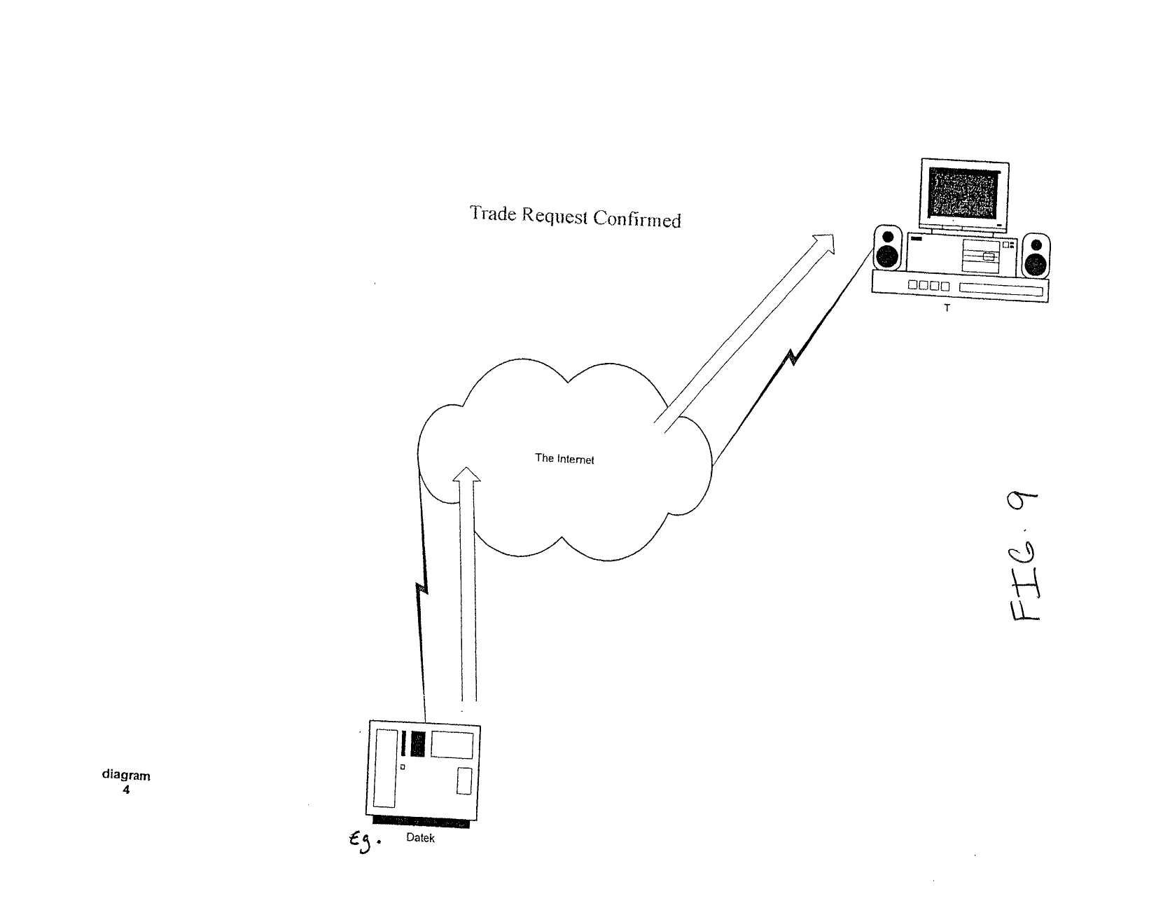

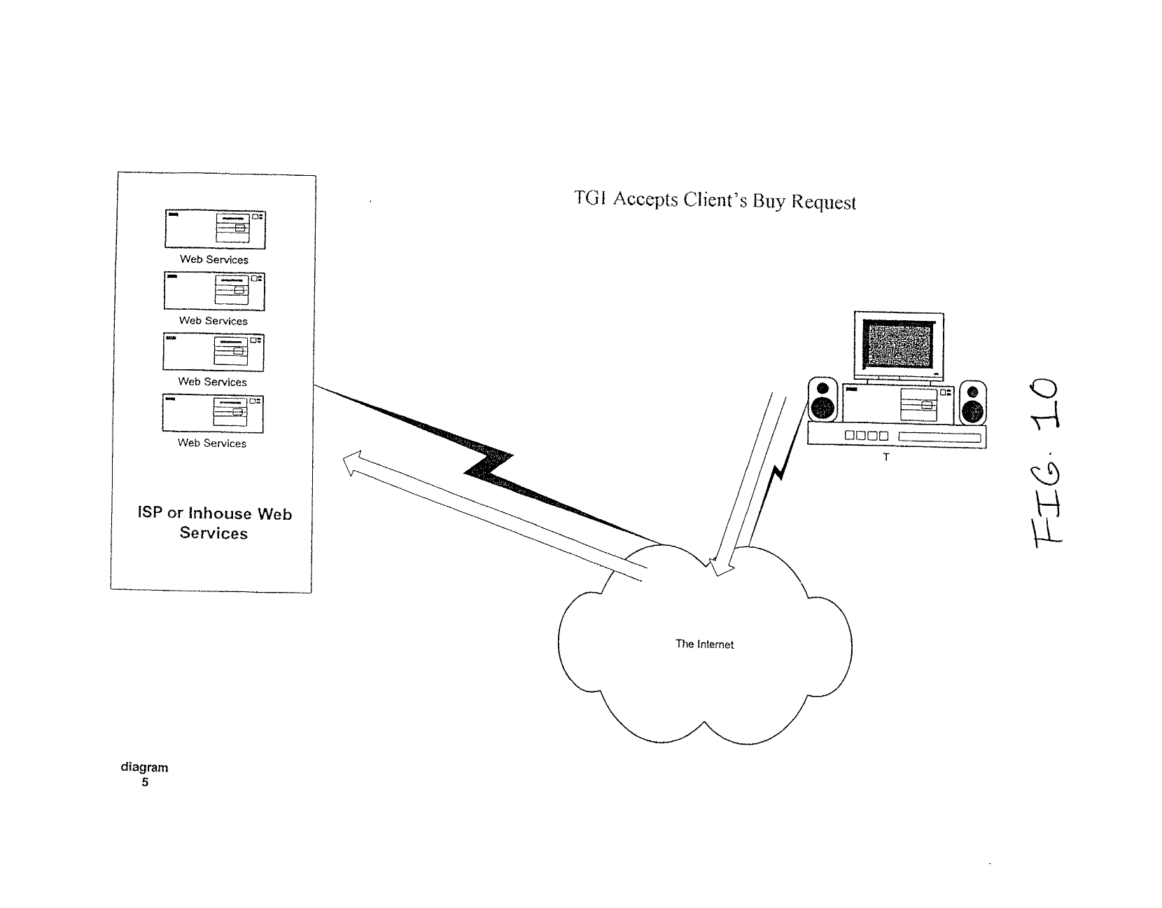

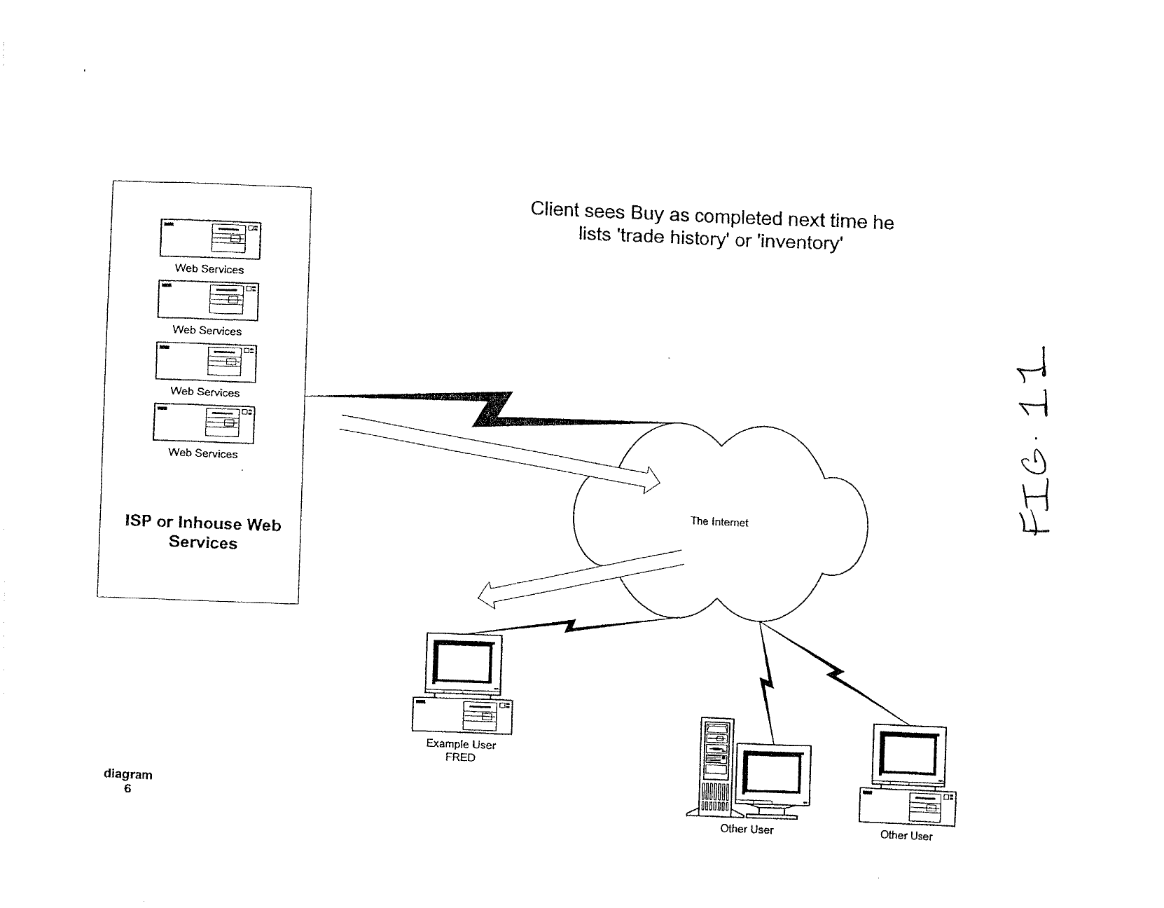

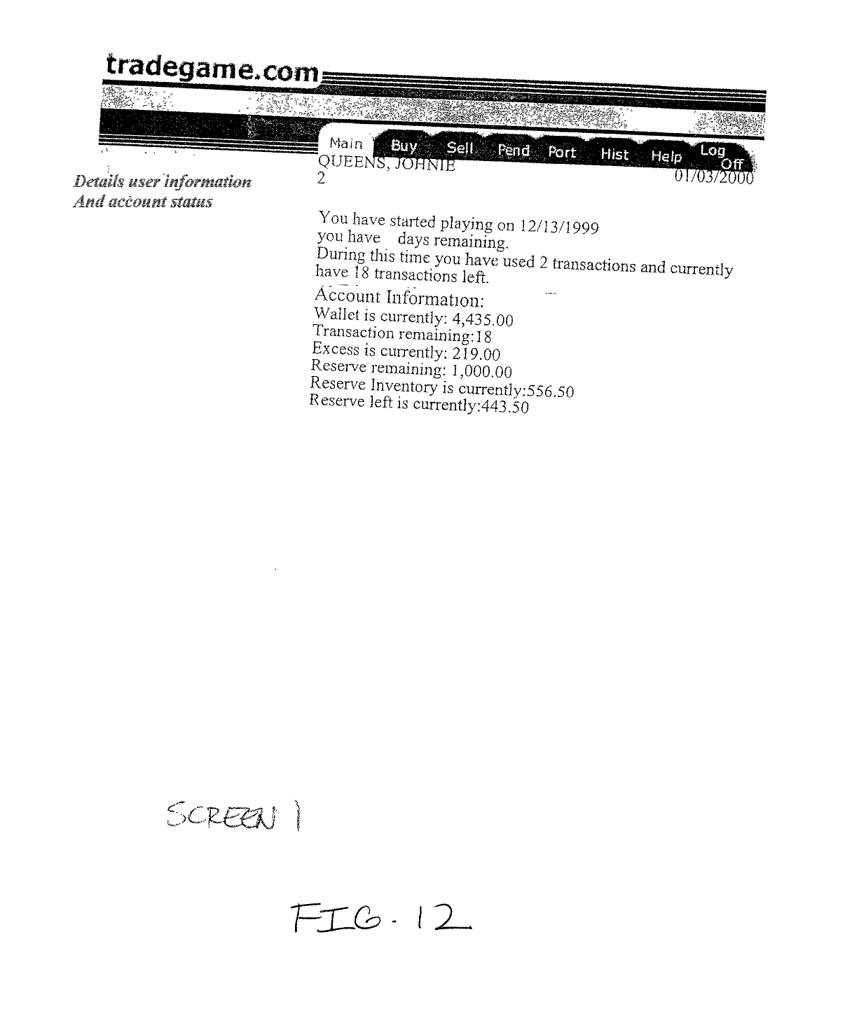

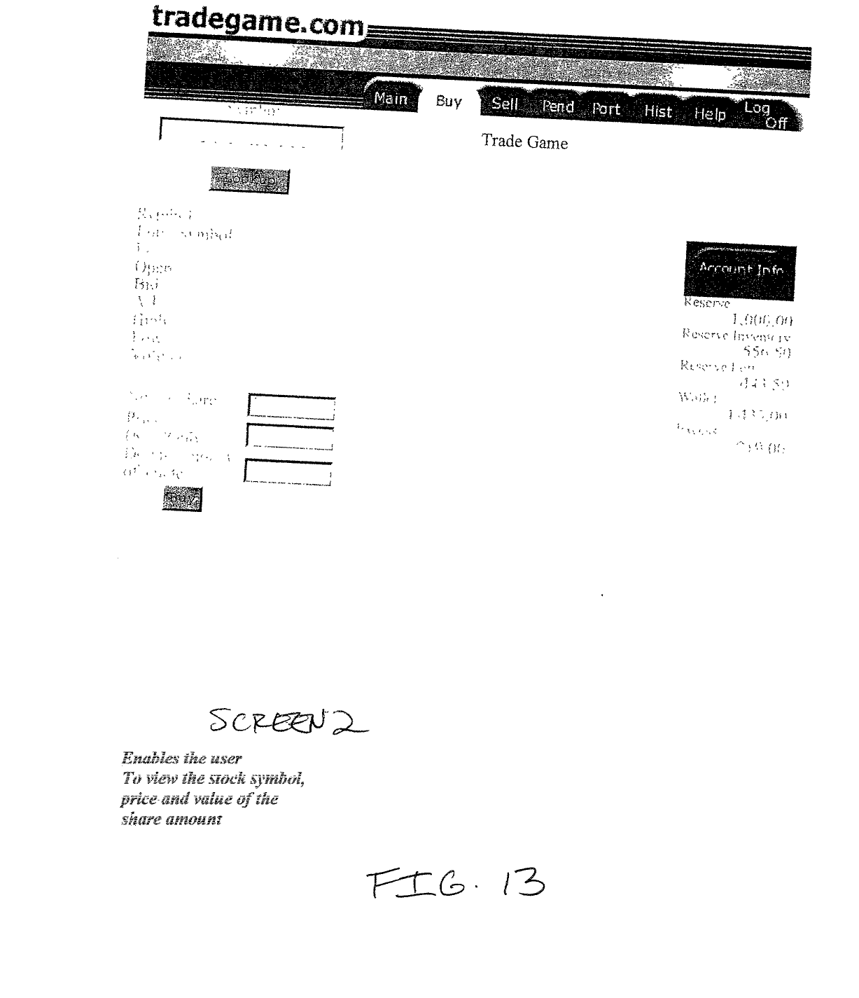

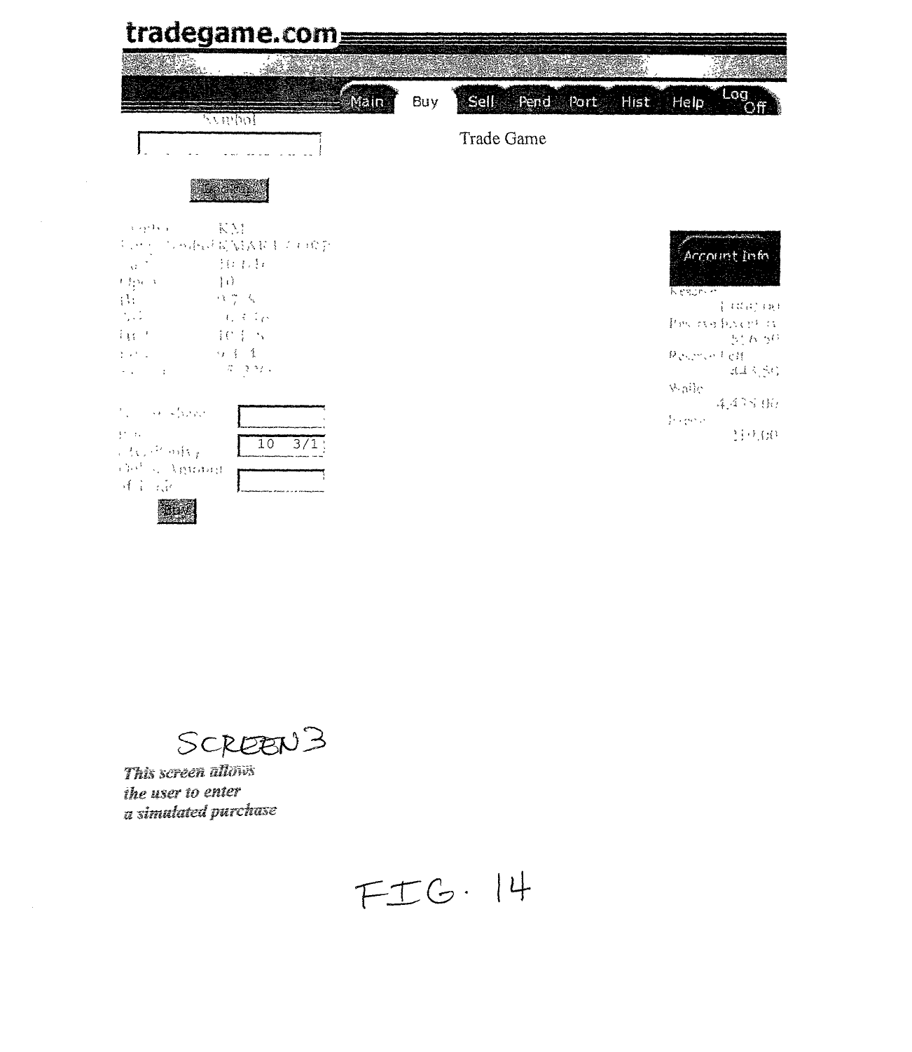

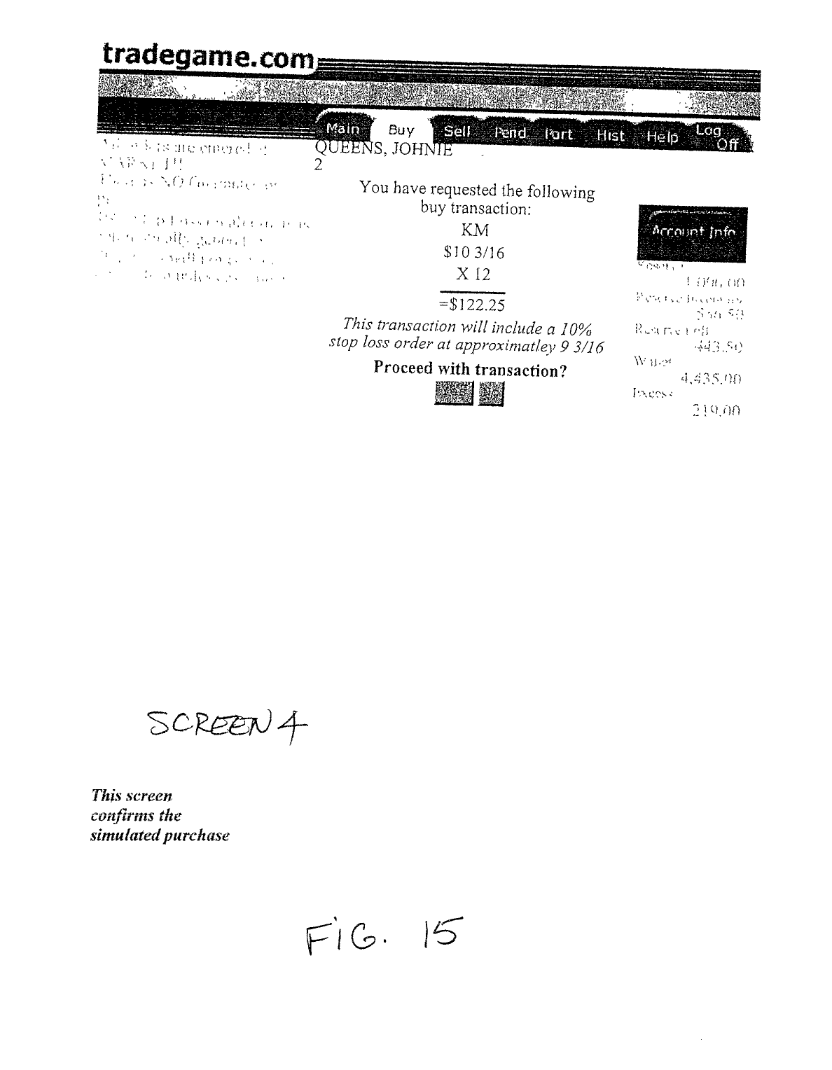

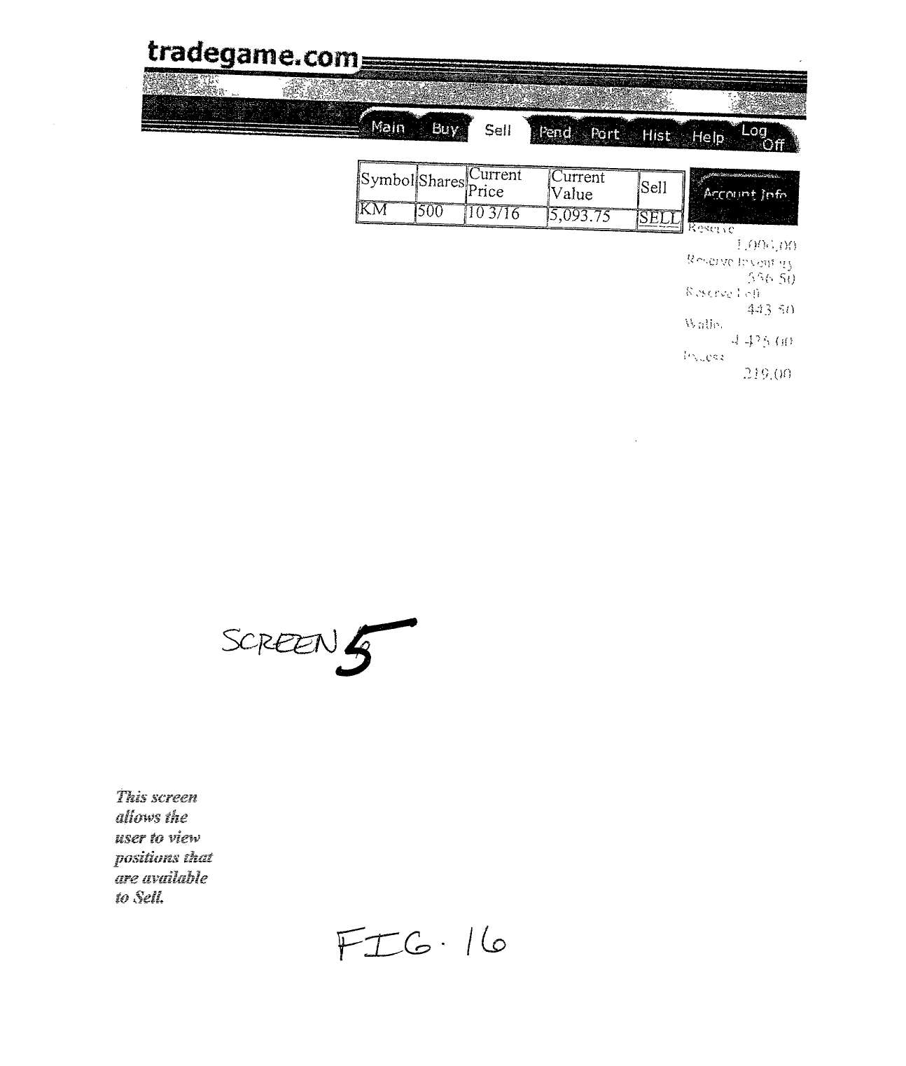

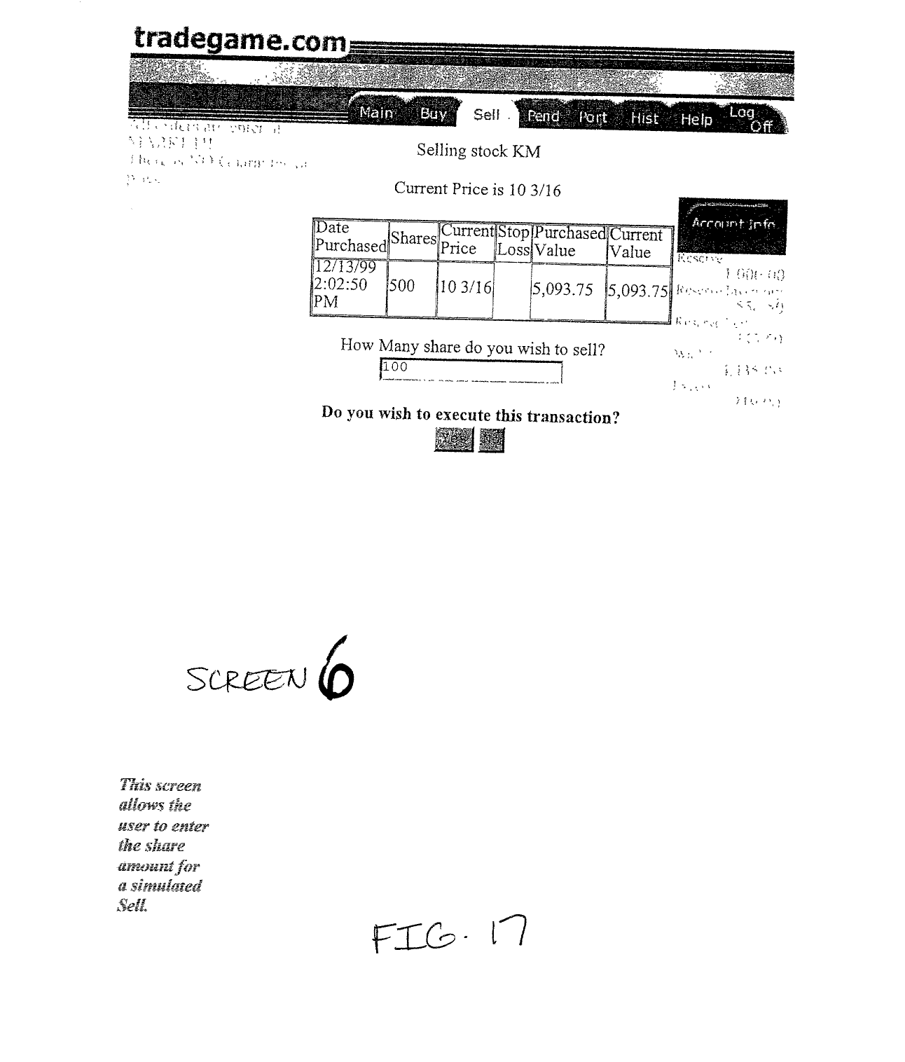

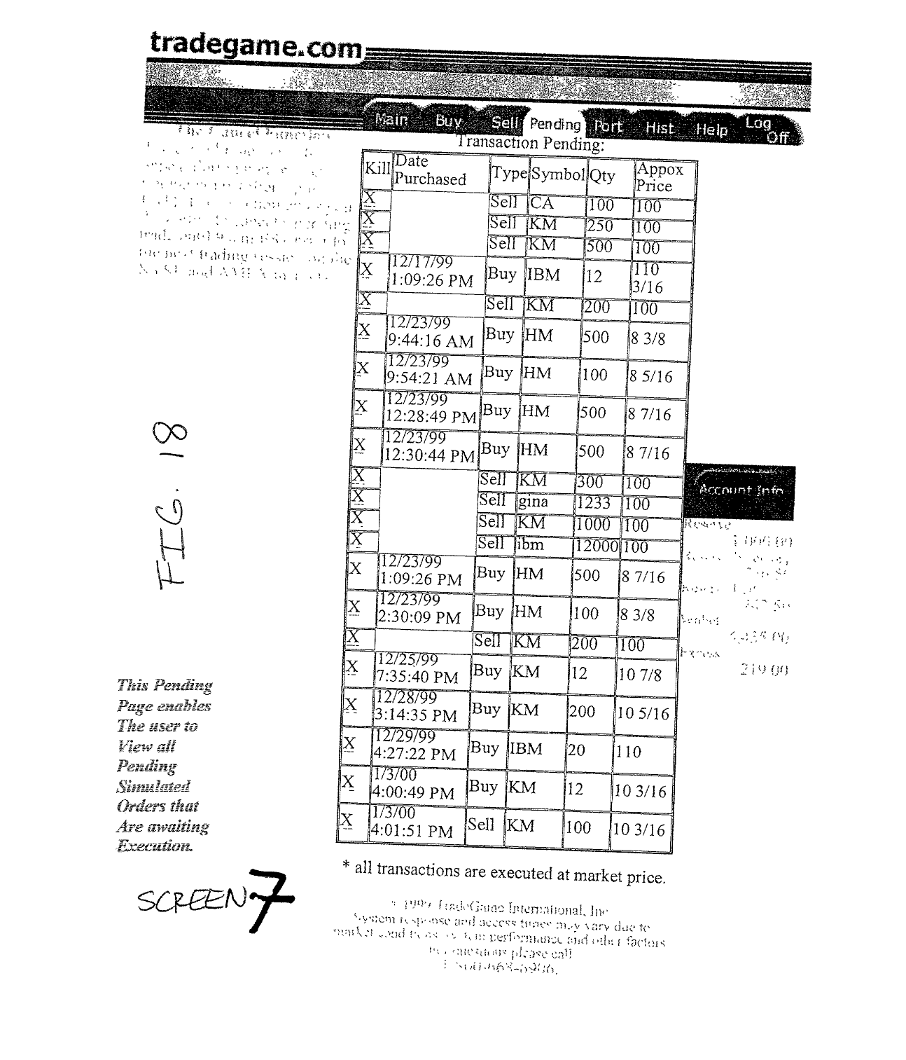

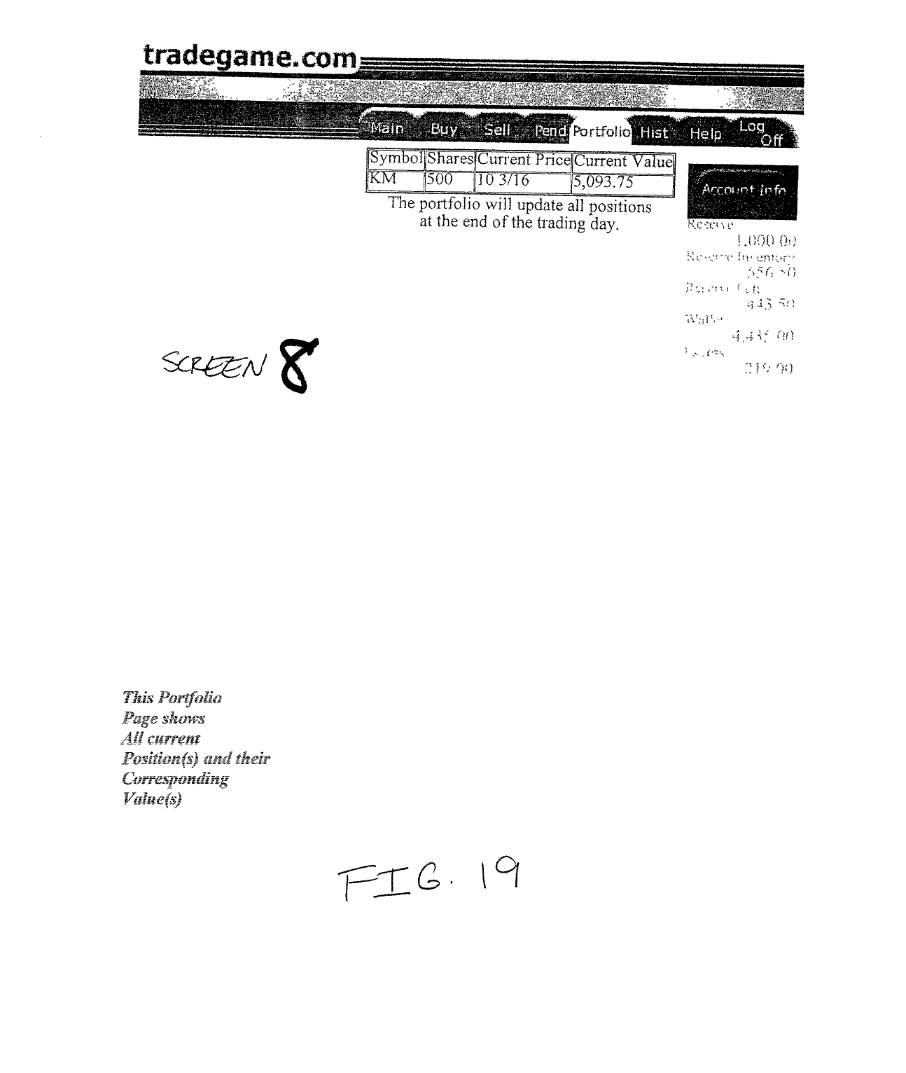

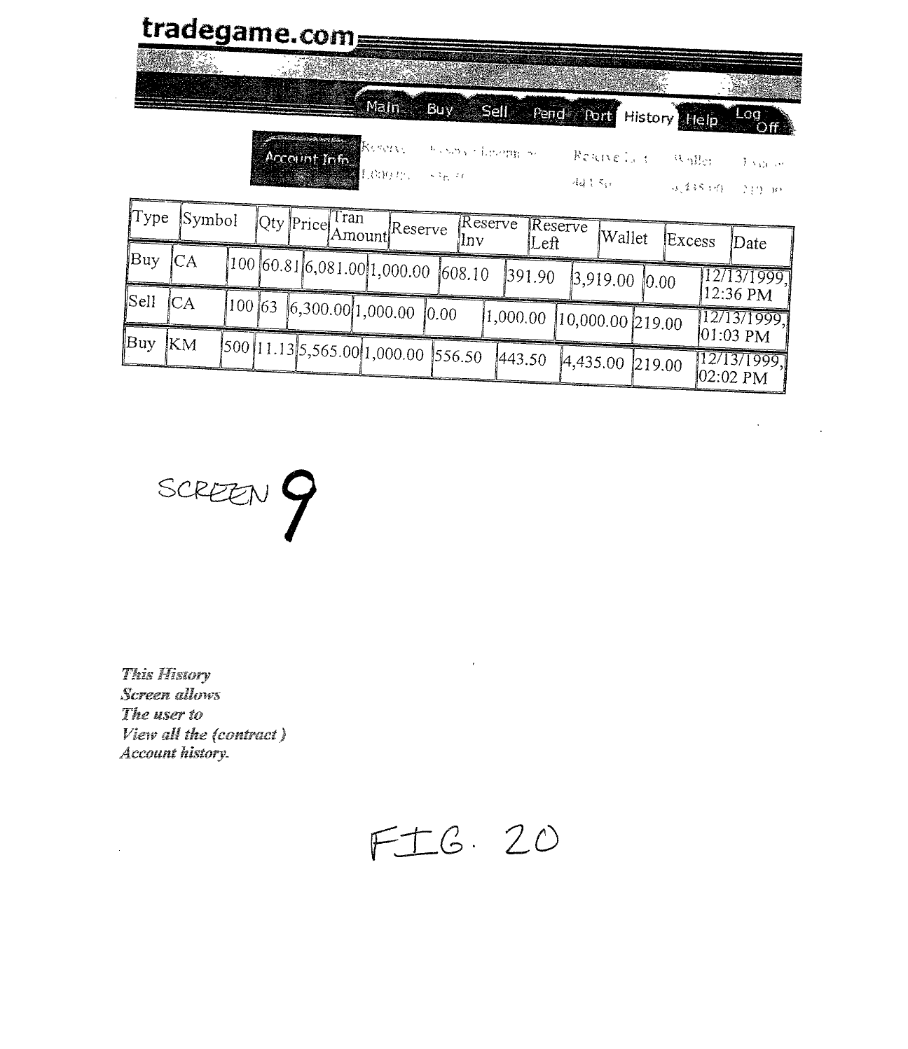

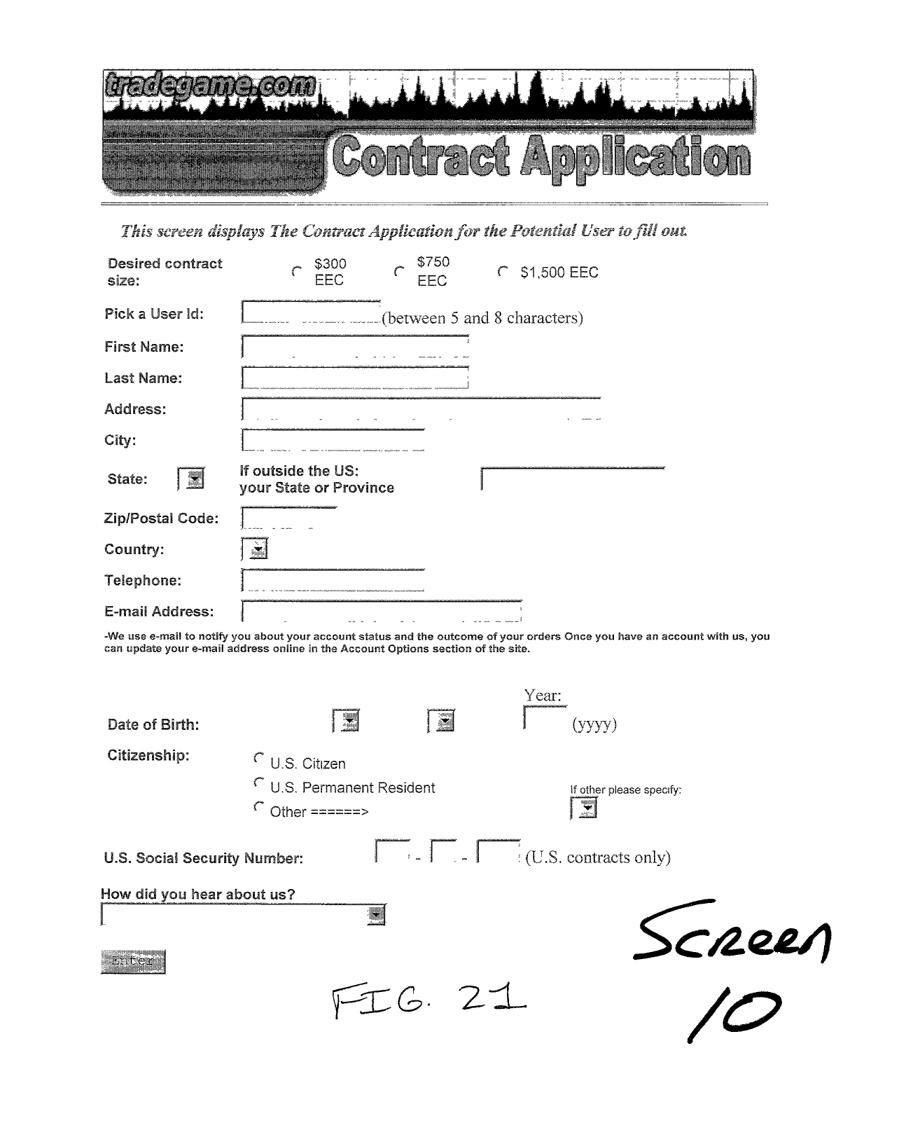

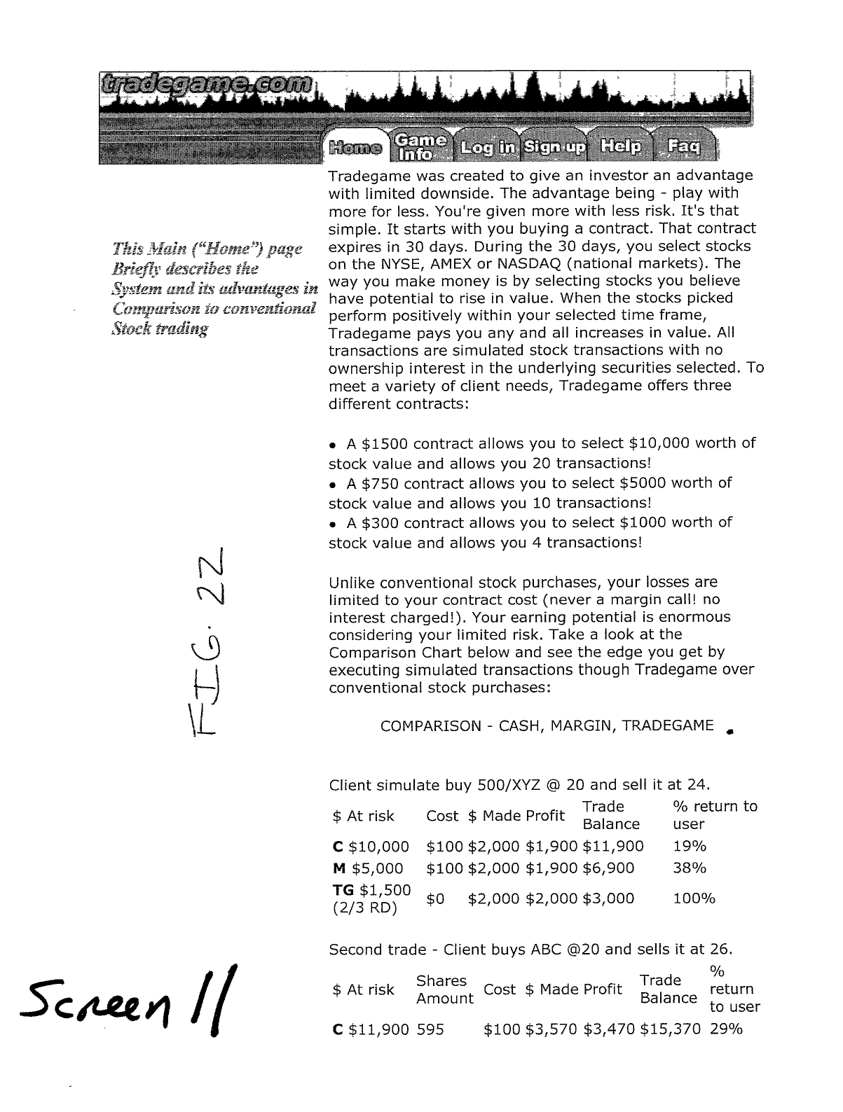

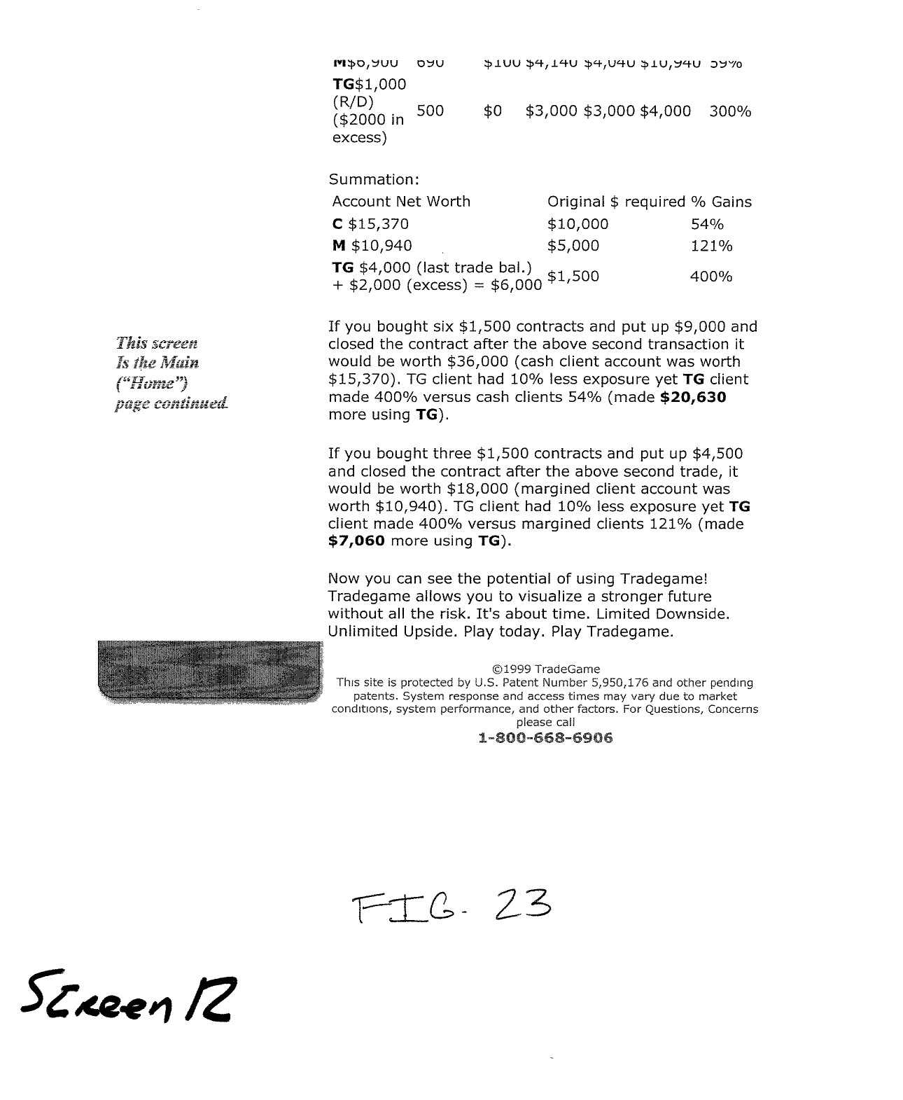

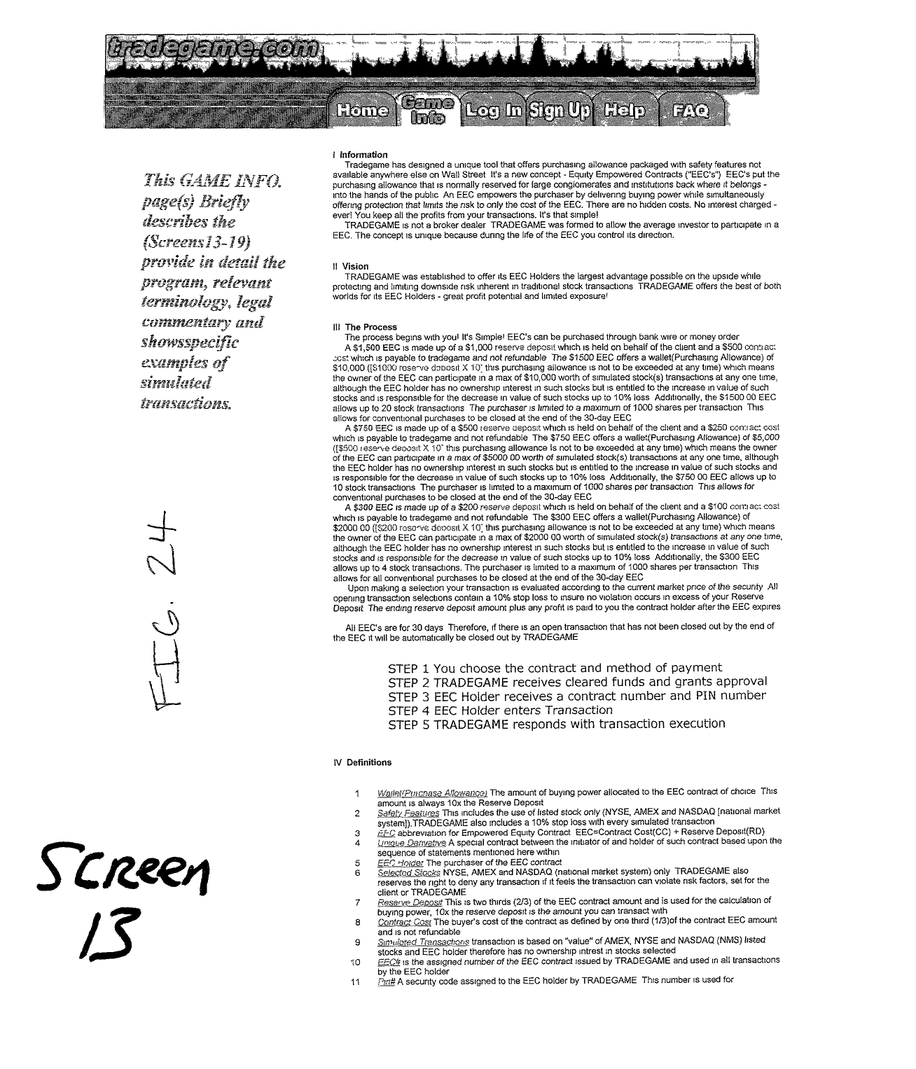

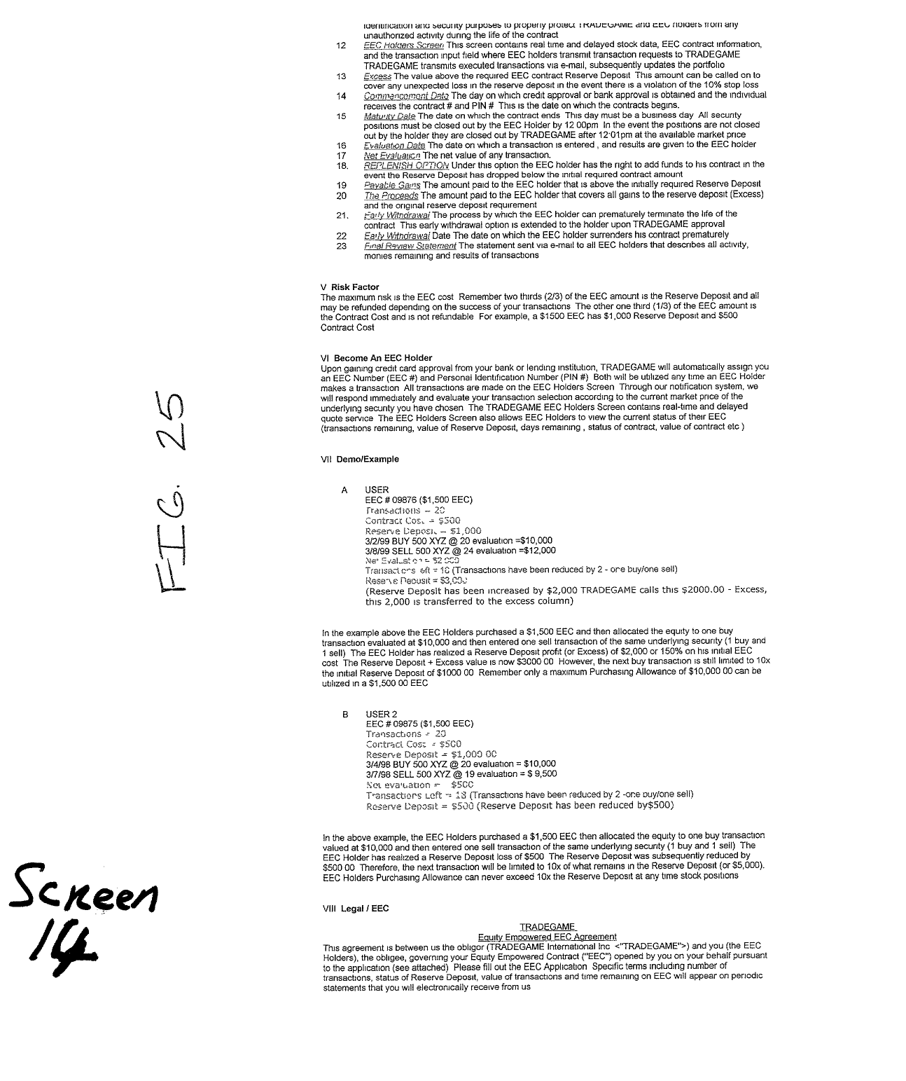

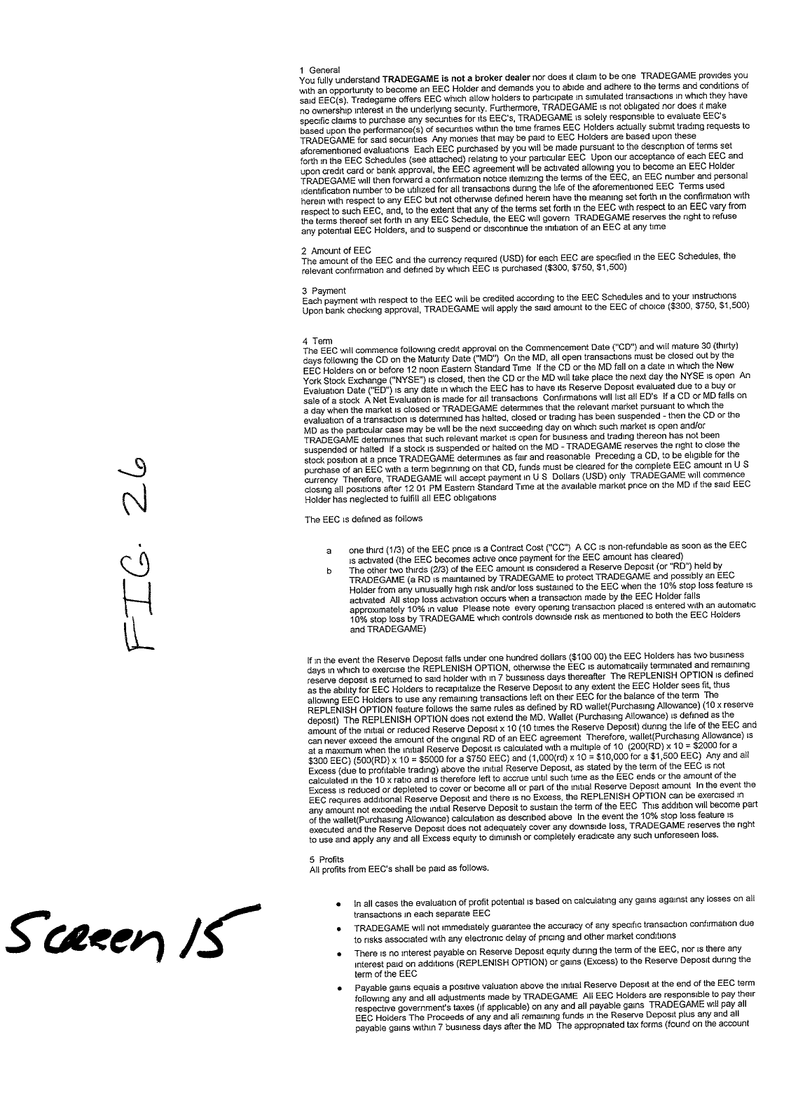

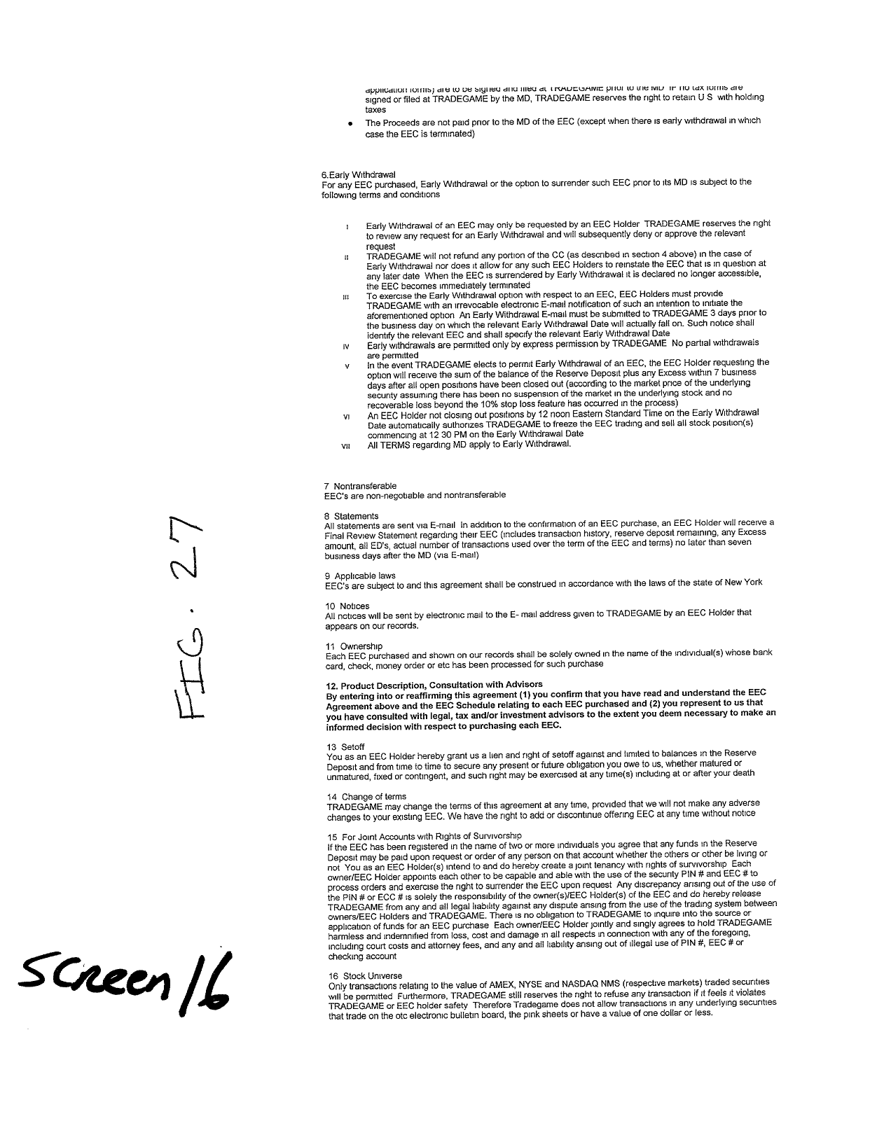

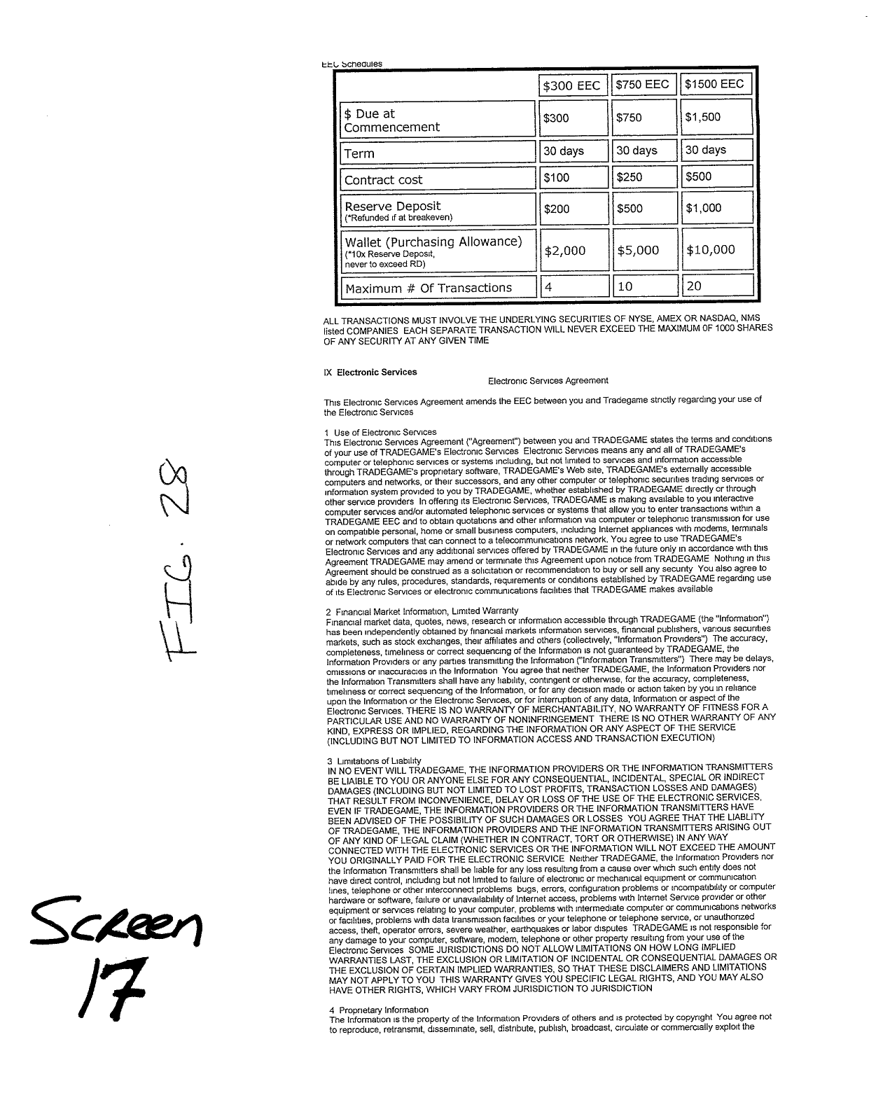

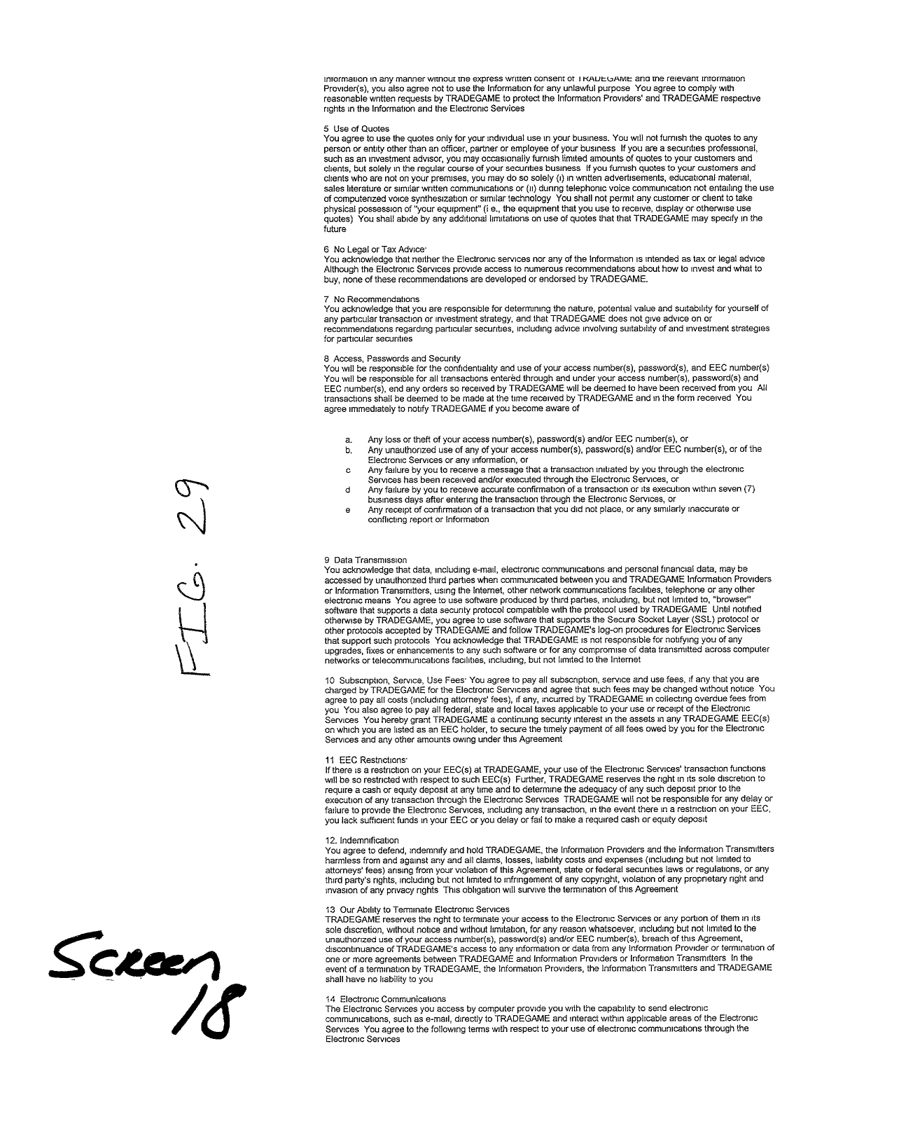

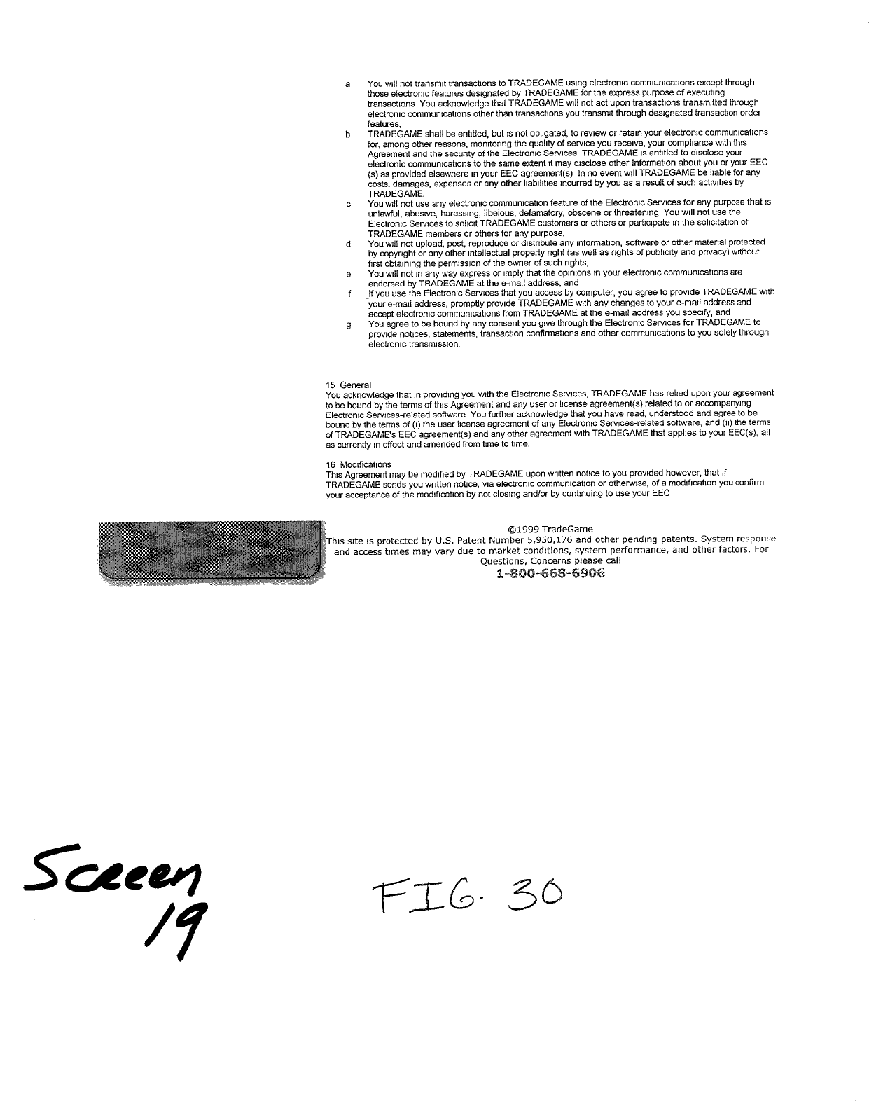

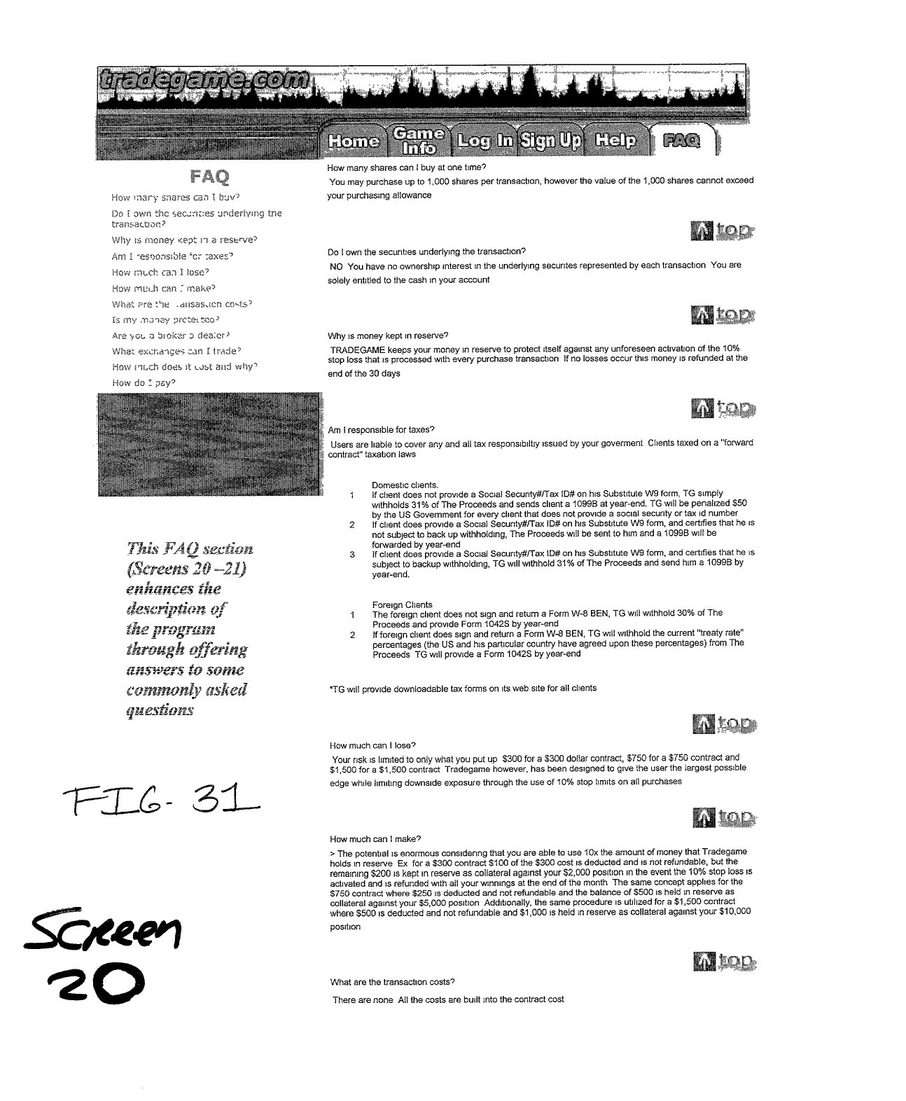

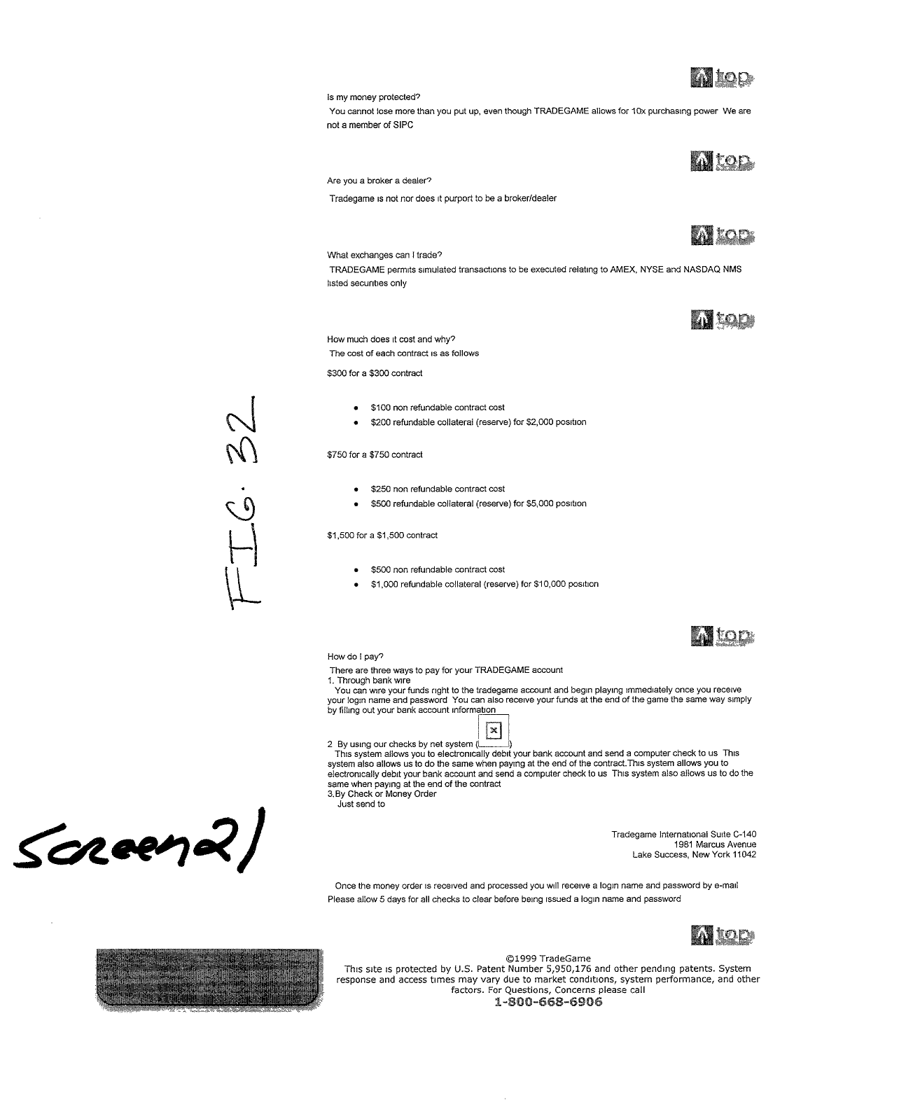

1) A one page block diagram, labeled FIG. 5, illustrating a computer network and a more detailed view of an exemplary financial transaction administrative system according to a preferred embodiment of the present invention. FIG. 5 depicts how transactions flow in and out of the administrative system from/to the Internet to/from an Internet Router through the Tradegame Firewall (to protect the system from hackers, viruses, etc.). The information all flows through the Tradegame Net (internal network) where it is divided between the actual web server (server for actual website where users place transactions and the data is then sent to or from the secure Database) and the Database ‘Server’ which stores all the transactions and allows the system to stay organized and operate within established parameters.

2) A six page transaction flow diagram, labeled Diagram 1 thru Diagram 6, respectively, illustrating an exemplary operational sequence for requesting financial transactions, e.g., placing a trade, according to a preferred embodiment of the present invention.

3) A set of 21 pages, labeled screen 1 thru screen 21, illustrating exemplary display screens for users of a financial transaction administrative system, such as via web pages, according to a preferred embodiment of the present invention.

Although specific embodiments of the invention have been disclosed, it will be understood by those having ordinary skill in the art that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

What is claimed is:

1. A financial transaction administration system comprising:
a computer network interface; and
a financial transaction administration center comprising:
a computer server coupled to the computer network interface for processing financial transaction requests received from users across a computer network; and
a database for tracking financial transaction parameters defined by at least one contract for each user, the financial transaction administration center limiting transactions requested by each user according to the at least one contract associated with the user, the at least one contract limiting the financial transactions for each user according to at least one of the time of a transaction, the user's equity in a transaction, and the number of trades permitted for the user.

2. The financial transaction administration system of claim 1, wherein the computer network is a wide area network.

3. The financial transaction administration system of claim 1, wherein the computer network is the Internet and the computer server operates with a web server to provide users access to the financial transaction administration system to place financial transaction requests via a web page.

4. The financial transaction administration system of claim 1, wherein the users place financial transaction requests and receive confirmation of their transactions via the computer server.

5. The financial transaction administration system of claim 1, wherein the computer network is the Internet and the computer server operates with a web server to provide users access to the financial transaction administration system to place financial transaction requests via a web page, and wherein the users receive confirmation of their requested transactions via emails across the Internet.

6. The financial transaction administration system of claim 1, wherein the users place financial transaction requests comprising stock trade requests.

7. The financial transaction administration system of claim 1, wherein one of the at least one contract for each user is an equity empowered trading contract.

8. The financial transaction administration system of claim 7, wherein each user places stock trade requests according to the limitations of their associated at least one equity empowered trading contract.

9. A financial transaction administration system comprising:
an Internet network interface;
a local area network;
at least one administration computer station coupled to the local area network; and
a financial transaction administration computer system, communicatively coupled to the local area network and to Internet network interface, the financial transaction administration computer system comprising:
a computer server communicatively coupled to the local area network and to the Internet network interface for processing financial transaction requests received from users across the Internet; and
a database for tracking financial transaction parameters defined by at least one contract for each user, the financial transaction administration computer system automatically limiting transactions requested by each user according to the at least one contract associated with the user, the at least one contract limiting the financial transactions for each user according to at least one of the time of a transaction, the user's equity in a transaction, and the number of trades permitted for the user.

10. The financial transaction administration system of claim 9, wherein the users place financial transaction requests comprising stock trade requests.

11. The financial transaction administration system of claim 10, wherein one of the at least one contract for each user is an equity empowered trading contract.

12. The financial transaction administration system of claim 11, wherein each user places stock trade requests according to the limitations of their associated equity empowered trading contract.

13. A method for a financial transaction administration system comprising the steps of:
receiving stock trade requests from users across a wide area network;
limiting stock trade requests made by at least one of the users according to a contract associated with the at least one user, the contract limiting stock trades requested by the user according to at least one of the time of a stock trade request, the user's equity in the requested stock trade transaction, and the number of stock trades permitted for the user.

14. The method of claim 13, wherein the users place stock trade requests via a web page across the Internet.

15. The method of claim 13, further comprising the step of:
confirming stock trade requests processed from particular users by sending email messages to the particular users that placed the stock trade requests.

16. The method of claim 15, wherein the confirming step includes the step of indicating to the particular users whether the stock trade requests processed from the particular users were accepted by the financial transaction administration system for placing stock trade transactions for the particular users.
